(19) United States
(12) Patent Application Publication
(10) Pub. No.: US 2009/0004457 A1
(43) Pub. Date: Jan. 1, 2009

(54) POLYMER FOAM COMPOSITE CONTAINING HOLLOW PARTICLES AND PROCESS FOR PREPARING THE SAME

(75) Inventors: Myung Dong Cho, Gyeonggi-do (KR); Dai Soo Lee, Seoul (KR)

Correspondence Address: CANTOR COLBURN, LLP, 20 Church Street, 22nd Floor, Hartford, CT, 06103, US

(73) Assignees: SAMSUNG ELECTRONICS CO., LTD., Suwon-si (KR); CHUNBUK NATIONAL UNIVERSITY INDUSTRIAL COOPERATION FOUNDATION, Jeonju-si (KR)

(21) Appl. No.: 12/060,300

(22) Filed: Apr. 1, 2008

(30) Foreign Application Priority Data
Jun. 28, 2007 (KR) 10-2007-0064373
Oct. 30, 2007 (KR) 10-2007-0109597

(51) Int. Cl. B32B 3/26; B29C 44/00

(52) U.S. Cl. 428/305.5; 428/313.3; 428/313.5; 264/45.1

(57) ABSTRACT

Disclosed is a polymer foam composite comprising a plurality of hollow cells. Each cell is defined by a cell wall. A plurality of hollow particles are contained in the cell wall. The hollow particles have a diameter in the range of about 100 nm to about 4 μm. The hollow portion of the hollow particle is filled with air, a fluorocarbon gas, a hydrocarbon gas, an inert gas or a mixture thereof. A process for manufacturing the polymer foam composite is also disclosed. A catalyst, a dispersant, a foaming agent, and hollow particles are added to a polyol to prepare a premixed polyol. Isocyanate is added to the premixed polyol to foam the premixed polyol and thereby form the polymer foam composite.

This application claims priority to Korean Patent Application No. 2007-64373, filed on Jun. 28, 2007 and Korean Patent Application No. 2007-109597, filed on Oct. 30, 2007, and all the benefits accruing therefrom under 35 U.S.C. §119, the contents of which in its entirety are hereby incorporated by reference.

### BACKGROUND OF THE INVENTION

This disclosure relates to a polymer foam composite and a process for preparing the same.

Polymer foam composites formed of, for example, polystyrene or polyurethane have been used as insulating materials for construction, refrigeration and other industrial uses due to their low thermal conductivity and high insulation effect. As a representative example, a polyurethane foam composite uses trichlorofluoromethane-11 (CFC-11) as a foaming agent. However, since the use of chlorofluorocarbon (CFC) is recently restricted to protect the ozone layer of the earth, the use of the polyurethane foam composite using the chlorofluorocarbon as a foaming agent is also restricted. Therefore, a demand for a new substitute of the foaming agent is on the rise. As a result, a polyurethane foam composite using hydrochlorifluorocarbon-141b (HCFC-141b) or cyclopentane as a foaming agent has been mass-produced. Such a polyurethane foam composite has a thermal conductivity (K-factor) of about 0.020 kcal/mh° C. In order to achieve the maximum volumetric efficiency, a thermal conductivity of about 0.0100 kcal/mh° C. or lower is necessary. However, it is difficult to realize such a low thermal conductivity with the present technology.

Vacuum insulating materials other than the polyurethane foam composite have a thermal conductivity of about 1/7 to 1/10 of that of the polyurethane foam composite. However, there is a big disadvantage in terms of the cost. In addition, the performance and structural deterioration occurs due to the vacuum loss during long term use. Thus, the vacuum insulating materials cannot be easily applied to the whole refrigerator. Therefore, there is a demand for a novel insulating material having a high energy efficiency and lightweight. As a result, a material such as aerogel has been developed and is currently under examination. However, aerogel have some problems in that the price and productivity of the material are not competitive, and the application of the material to the refrigerator is not easy.

Many attempts have been made to improve the insulation characteristic of a foamed composite using a foaming agent other than chlorofluorocarbon. For example, a method for reducing the total thermal conductivity consists of using hollow particles of foamed urethane, where the hollow particles exist as independent cells. As an example, the Korean Patent Application Laid-Open No. 2003-0015511 discloses a technique, in which vacuum beads having a relatively large size are added in the preparation of a polyurethane foam composite so to improve insulation. In this technology, however, the hollow particles themselves tend to behave independently of the urethane foam composite cells. Therefore, it provides a limited effect in improving the insulation efficiency.

### BRIEF SUMMARY OF THE INVENTION

Disclosed is a polymer foam composite which comprises a plurality of cells and cell walls enclosing the cells, in which a plurality of hollow particles is contained in the cell walls.

Disclosed is a process for preparing a polymer foam composite. The process comprises adding a catalyst, a dispersant, and a foaming agent to the polyol to prepare a premixed polyol, adding hollow particles to the premixed polyol, and adding isocyanate to the mixture of the premixed polyol and the hollow particles to foam the mixture.

Disclosed is a process for preparing a polymer foam composite. The process comprises adding hollow particles to a polyol, adding a catalyst, a dispersant, and a foaming agent to the polyol-hollow particle mixture to prepare a premixed polyol, and adding isocyanate to the premixed polyol containing the hollow particles to foam the mixture.

Disclosed is a process for preparing a polymer foam composition. The process comprises adding hollow particles to isocyanate, adding a catalyst, a dispersant, and a foaming agent to the polyol to prepare a premixed polyol, and adding the premixed polyol to the mixture of the isocyanate and the hollow particles to foam the mixture.

Disclosed is the polymer foam composite having hollow particles dispersed in the cell walls. The hollow particles function as an insulator. The hollow portion of the hollow particle is filled with air, a fluorocarbon gas, a hydrocarbon gas, an inert gas or a mixture thereof. Therefore, thermal conductivity at the solid parts of the outer cell walls can be reduced. In addition, the polymer foam composite can ensure high energy efficiency by using the cell walls effectively and excellent volumetric efficiency by being compact. Thus, the polymer foam composite is thin and excellent in the insulation effect.

### BRIEF DESCRIPTION OF THE DRAWINGS

The above and other features and advantages of the disclosed embodiments will become more apparent by describing in detail exemplary embodiments thereof with reference to the attached drawings, in which:

FIG. 1 is a schematic perspective view of a polymer foam composite;

FIG. 2 is a schematic cross-sectional view of a hollow particle contained in the cell walls of a polymer foam composite;

FIG. 3 is a SEM photograph of a polyurethane foam composite prepared in Example 1;

FIG. 4 is a SEM photograph showing hollow particles dispersed in the cell walls of a polyurethane foam composite prepared in Example 1; and

FIG. 5 is a graph showing variations in thermal conductivity of a polymer foam composite prepared in Comparative Example 1 and Examples 2 to 6 in response to the content of hollow particles.

### DETAILED DESCRIPTION OF THE EMBODIMENTS

Hereinafter, disclosed embodiments will now be described in greater detail with reference to the accompanying drawings.

The terminology used herein is for the purpose of describing particular embodiments only and is not intended to be limiting of the invention. As used herein, the singular forms “a”, “an” and “the” are intended to include the plural forms as well, unless the context clearly indicates otherwise. The use of the terms “first”, “second”, and the like do not imply any particular order but are included to identify individual elements. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements and the thicknesses of layer and regions are exaggerated for clarity.

Disclosed embodiments are directed to a polymer foam composite comprising a plurality of hollow cells, cell walls, and a plurality of hollow particles contained in the cell walls.

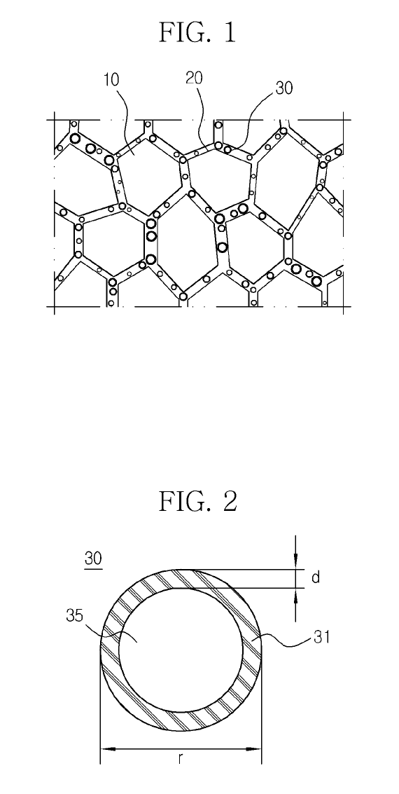

FIG. 1 is a schematic perspective view of the polymer foam composite. Referring to FIG. 1, the foam composite comprises a plurality of cells 10, cell walls 20, and a plurality of hollow particles 30 dispersed in and along the cell walls 20.

The thermal conductivity of the foam composite is determined by the interaction of each different heat transfer mechanisms as in the following equation.

λₜₒₜₐₗ=λ_{gas}λ_{solid}+λ_{radiation}

λ_{gas} heat transfer via air convection or other gases in the cells;

λ_{solid}: heat transfer via solid parts of the cell walls or polymer matrix itself of the foam composite; and

λ_{radiation}: heat transfer via radiation in the foam composite.

In this embodiment, the hollow particles 30 are positioned in and along the cell walls 20 to reduce the thermal conductivity of the cell walls 20 so that the heat transfer of the λ_{solid} portion is minimized. Thus, the polymer foam composite can provide an improved-insulation performance.

The hollow particles 30 can be produced using an emulsion polymerization method using a nozzle reactor system (e.g., spray drying or pyrolysis). However, this method cannot produce hollow particles having a sub-micron size. An emulsion method integrated with a sol-gel method may be used in order to produce hollow particles of sub-micron.

FIG. 2 is a schematic cross-sectional view of a hollow particle 30 contained in the cell walls 20 of the polymer foam composite. The hollow particle 30 comprises an outer wall 31 and a hollow portion 35 inside of the outer wall 31. The cell walls 20 of the polymer foam composite have a thickness of about 4 to about 10 μm. The hollow particle 30 has a diameter (r) of about 100 nm to about 4 μm. The outer wall 31 has a thickness of about 50 nm to about 100 nm.

Materials for the hollow particles 30 are not particularly limited, but metals, metal oxides, polymers or the like may be used. More specifically, the hollow particles 30 may be formed of a homopolymer or a copolymer selected from the group consisting of polyethylene, polypropylene, polystyrene, polyvinyl chloride, polyvinylidene chloride, polyvinyl acetate, polyacrylate-polyester, silane, silicone, polyacrylonitrile, polyacrylate, polymethyl methacrylate, and a mixture thereof.

The hollow portion 35 of the hollow particle 30 may be filled with air, a fluorocarbon gas, a hydrocarbon gas, an inert gas alone or a mixture thereof. The hollow portion 35 functions as an insulator.

The shape of the hollow particle 30 is not particularly limited. For example, a hollow particle can have an arbitrary shape such as a sphere, a polyhedron, a rod or the like.

The polymers forming the foam composite comprise olefin resins, polyamide resins, polyurethane resins, polystyrene resins, or the like. Polyurethane resins can be preferably used.

Hereafter, a method of preparing a polyurethane foam composite having hollow particles is explained.

In this embodiment, first, a catalyst, a dispersant and a foaming agent are added to a polyol to prepare a premixed polyol. Subsequently, hollow particles are added to the above-prepared premixed polyol. Then, isocyanate is added to the mixture of the premixed polyol and hollow particles to foam the mixture.

In another embodiment, hollow particles are added to a polyol to form a homogeneous polyol-hollow particle mixture. A catalyst, a dispersant and a foaming agent are added to the polyol-hollow particle mixture to prepare a premixed polyol. Subsequently, isocyanate was added to the premixed polyol containing the hollow particles to foam the mixture.

In another embodiment, hollow particles are added to isocyanate to form a mixture of hollow particle and isocyanate. In addition, a catalyst, a dispersant and a foaming agent are added to a polyol to prepare a premixed polyol. Subsequently, the premixed polyol is added to the mixture of hollow particles and isocyanate to foam the mixture.

Hereafter, an example of manufacturing a polyurethane foam composite is explained.

The premixed polyol is for forming a urethane skeleton by reacting it with a hardening agent. The physical property of the final foam composite product is mainly determined by the premixed polyol, for example, to the extent of about 80%.

The hollow particles are added in the amount of about 2 to about 20 weight % based on the polyol.

When the content of the hollow particles exceeds 20% by weight, the mixing of the hollow particles is not well performed, and the mechanical properties of the polyurethane foam composite is deteriorated. When the content of the hollow particles is less than 20% by weight, the insulation effect is too weak.

The mixture of the polyol comprising hollow particles and isocyanate is stirred at 4000 to 7000 rpm for 5 to 10 seconds. Then, the following Reaction 1 is initiated after about 10 to 15 seconds, and foaming is carried out.

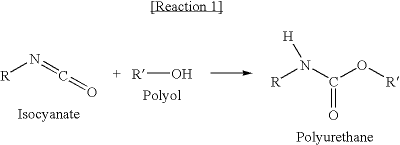

The cell wall 20 of the polyurethane foam composite has a thickness of about 4 μm to about 10 μm. The hollow particle has a diameter (r) of about 100 nm to about 4 μm. The outer wall of the hollow particle has a thickness (d) of about 50 nm to about 100 nm.

Materials for the hollow particles 30 are not particularly limited. The hollow particles 30 can be formed of a material selected from the group consisting of metals, metal oxides, and polymers. More specifically, the hollow particles 30 can be formed of a homopolymer or a copolymer selected from the group consisting of polyethylene, polypropylene, polystyrene, polyvinyl chloride, polyvinylidene chloride, polyvinyl acetate, polyacrylate-polyester, silane, silicone, polyacrylonitrile, polyacrylate, polymethyl methacrylate, and a mixture thereof.

The hollow portion 35 of the hollow particles 30 is filled with air, a fluorocarbon gas, a hydrocarbon gas, or an inert gas alone or a mixture thereof. The hollow portion 35 functions as an insulator.

Shapes of the hollow particle 30 is not particularly limited. For example, a hollow particle can have an arbitrary shape such as a sphere, a polyhedron or a rod.

The polyol is an aliphatic compound having two or more hydroxyl groups within the molecule. The polyol, for example, comprises polypropylene glycol polyols, amine terminated polyether polyols, polytetramethylene ether glycol polyol, adipic acid (which is one of polyester polyols, phthalic anhydride terephthalic acid), or the like, but not particularly limited thereto.

As the foaming agent, water can be used. Further, other foaming agents can be used together with water. Examples of the foaming agent other than water comprise n-pentane, isopentane, cyclopentane, methylene chloride, 1,1,1,2-tetrafluoroethane, 1,1,1,3,3,-pentafluoropropane, 1,1,1,3,3,-pentafluorobutane, 1,1-dichloro-1-fluoroethane, 1-chloro-1,1-difluoroethane, chlorodifluoromethane, or the like.

In order to improve the foaming property, reaction time and breathability of a foam composite, and to minimize the density deviation, an appropriate catalyst and its amount are to be determined. Examples of the catalyst comprise diamine catalysts such as triethylamine, diethanolamine, N,N,N′,N′-tetramethylhexanediamine, N,N,N′,N′-tetramethylethylenediamine, triethylenediamine, N-methylmorpholine, dimethylaminoethanol, bis(2-dimethylaminoethyl)ether or 1,8-diazabicyclo-(5,4,0)-undecene-7, organometallic catalysts such as dibutyltin dilaurate, dibutyltin diacetate, stannous octoate, dibutyltin mercaptide, dibutyltin thiocarboxylate, dibutyltin maleate, dioctyltin mercaptide, dioctyltin thiocarboxylate, phenylmercury, silver propionate or tin octanoate. Among these catalysts, an amine catalyst is indispensable, and if necessary, an organometallic catalyst may be added. It is also possible to co-use a plurality of catalysts. Among these catalysts, a tertiary amine is preferably used. The reactivity of an amine catalyst is determined by the level of basicity and steric hindrance.

The dispersant is a silicone dispersant that improves miscibility by reducing the surface tension and unifies the produced bubble size. Further, the dispersant provides stability to the foam composite by controlling the cell structure of the foam composite.

The isocyanate comprise methylene diphenyl diisocyanate (MDI), polymeric methylene diphenyl diisocyanate, toluene diisocyanate (TDI), hexamethylene diisocyanate, trimethyl hexamethylene diisocyanate, phenylene diisocyanate, dimethyl diphenyl diisocyanate, tetramethylene diisocyanate, isoholon diisocyanate, naphthalene diisocyanate, triphenyl methane triisocyanate, and a mixture thereof. However, the isocyanate is not limited to the above.

The polyurethane foam composite can be foamed to have various shapes and structures, along with excellent insulation characteristic and production processability, thereby providing a variety of applications as an insulating material. When foaming the polyurethane composite, various methods such as an injection method, a kneading method, a dispersing method, or the like may be used.

Hereinafter, the following examples are given for the purpose of illustration and are not to be construed as limiting the scope of the invention.

### EXAMPLES

### Example 1

A cyclopentane foaming agent, an amine catalyst (Poly Cat (PC) series manufactured by Air Product and Chemical, Inc.) and a silicone dispersant (surfactant B series manufactured by Gold Smith) were added to a molecular weight of about 500 of polyether polyol (manufactured by Basf Corp.) having 4 or more functional groups to prepare a premixed polyol.

Polystyrene hollow particles having a diameter of 500 nm were added to the premixed polyol and mixed with each other for about 1 to 3 minutes using a homogenizer so that the polyol and the hollow particles are mixed homogeneously. Polymeric methylene diphenyl diisocyanate (PMDI) was added to the mixture, and stirred at 5000 rpm for about 5 to 10 seconds to prepare a polyurethane foam composite. The content ratio of each component used in the preparation of the polyurethane foam composite is listed in Table 1.

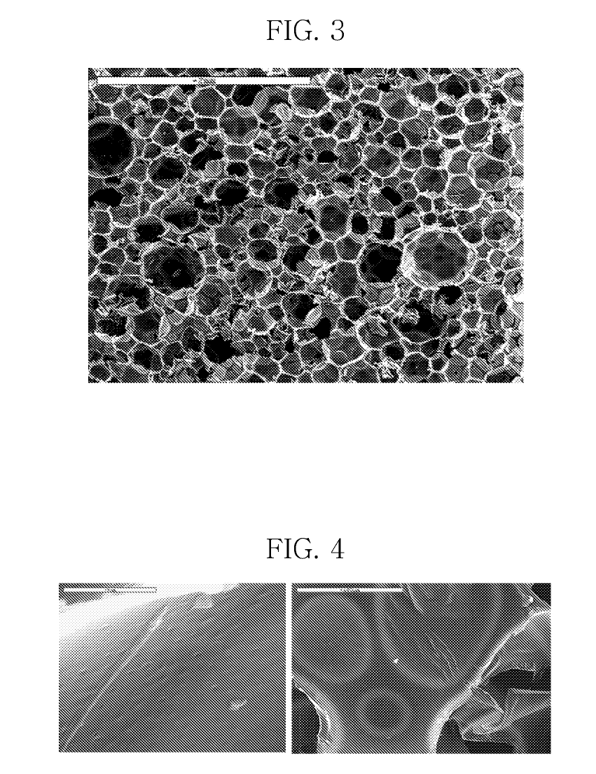

SEM photograph of the polyurethane prepared according to Example 1 is illustrated in FIG. 3. As shown in FIG. 3, it was confirmed that the polyurethane foam composite prepared in the Example 1 had spherical hollow structures in various sizes formed in the cell wall enclosing the hollow cell.

The SEM photograph showing hollow particles dispersed in the cell wall of the polyurethane foam composite, which was prepared by Example 1, is illustrated in FIG. 4. Referring to FIG. 4, the cell walls of the urethane foam composite has a thickness of about 7 μm, and hollow particles with a diameter of about 500 nm are dispersed in the cell walls. As a result, it can be seen that the surface of the cell walls of the polyurethane foam composite is bulged.

### Examples 2 to 6

A polyurethane foam composite was prepared in the same manner as in Example 1, except that hollow particles with a diameter of 700 nm were used and that the content of the hollow particles varied as shown in Table 1 based on 100 parts by weight of the premixed polyol.

### Example 7

Hollow particles having a diameter of 500 nm were added to a molecular weight of about 500 of polyether polyol (manufactured by Basf Corp.) having 4 or more functional groups and mixed with each other for about 1 to 3 minutes using a homogenizer, such that the polyol and the hollow particles are mixed homogeneously. Then, a cyclopentane foaming agent, an amine catalyst (Poly Cat (PC) series manufactured by Air Product and Chemical, Inc.), and a silicone dispersant (surfactant B series manufactured by Gold Smith) were added to the polyol-hollow particle mixture to prepare a premixed polyol.

Polymeric methylene diphenyl diisocyanate (PMDI) was added to the premixed polyol, and stirred at 5000 rpm for about 5 to 10 seconds to prepare a polyurethane foam composite. The content ratio of each component used in the preparation of the polyurethane foam composite is identical to Example 1 and listed in Table 1.

### Example 8

A polyurethane foam composite was prepared in the same manner as in Example 1, except that hollow particles with a diameter of 2 μm were used.

### Example 9

A polyurethane foam composite was prepared in the same manner as in Example 1, except that hollow particles with a diameter of 3 μm were used.

### Example 10

A polyurethane foam composite was prepared in the same manner as in Example 1, except that hollow particles with a diameter of 4 μm were used.

### Comparative Example

A polyurethane foam composite was prepared in the same manner as in Example 1, except that hollow particles were not added.

### Thermal Conductivity Measurement

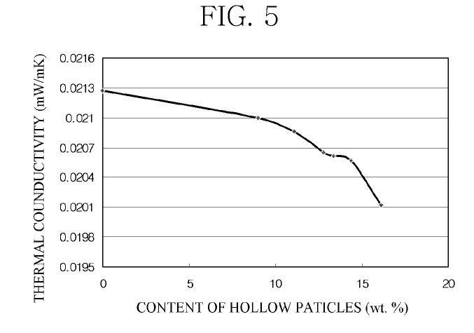

The thermal conductivity was measured with respect to the polyurethane foam composites prepared in Examples 1 to 10 and Comparative Example using a heat flow method. The results are shown in Table 1. The thermal conductivities of the polyurethane foam composites prepared in Comparative Example and Examples 1 to 6 are shown in the graph of FIG. 5. The thermal conductivity value was obtained by calculating the speed of heat transfer, the amount of heat, and area at the time of applying heat from the upper heat sensitive plate to the lower heat sensitive plate using a HC-074-200 (heat flow method) measuring equipment manufactured by EKO Instruments Co., Ltd.

TABLE 1

| | | Content ratio | | | | | |
|---|---|---|---|---|---|---|---|
| | | (wt %) | | | | | |
| | | | | | Methylene | | |
| | | | | | diphenyl | | Thermal |
| | Polyester | Amine | Silicone | Cyclopentane | diisocyanate | Hollow | conductivity |
| | polyol | catalyst | dispersant | forming agent | (MDI) | particles | (W/mK) |
| Comp. | 100 | 2 | 3 | 18 | 112 | 0 | 21.267 |
| Ex. 1 | | | | | | | |
| Ex. 1 | 100 | 2 | 3 | 18 | 112 | 10 | 21.000 |
| Ex. 2 | 100 | 2 | 3 | 18 | 112 | 11.1 | 20.860 |
| Ex. 3 | 100 | 2 | 3 | 18 | 112 | 12.8 | 20.654 |
| Ex. 4 | 100 | 2 | 3 | 18 | 112 | 13.4 | 20.610 |
| Ex. 5 | 100 | 2 | 3 | 18 | 112 | 14.4 | 20.570 |
| Ex. 6 | 100 | 2 | 3 | 18 | 112 | 16.1 | 20.120 |
| Ex. 7 | 100 | 2 | 3 | 18 | 112 | 10 | 20.893 |
| Ex. 8 | 100 | 2 | 3 | 18 | 112 | 10 | 21.279 |
| Ex. 9 | 100 | 2 | 3 | 18 | 112 | 10 | 21.512 |
| Ex. 10 | 100 | 2 | 3 | 18 | 112 | 10 | 20.930 |

As can be seen from the results of the thermal conductivities in Comparative Example and Examples 1 to 7 of Table 1 and FIG. 5, the thermal conductivity decreases as the content of the hollow particles increases. This is because the hollow particles are dispersed in the cell walls of the urethane foam composite such that the heat transfer at the solid part of the outer cell wall is interrupted. As can be seen from the results of Example 7, the same characteristics exhibited even though the step of adding the hollow particles was differed in the preparation process of the polyurethane foam composite. The diameters of the hollow particles used in Examples 8 to 10 are 2, 3, and 4 μm, respectively, which are larger than the sizes of the hollow particles used in Example 1 to 7. In general, the larger the size of the hollow particles, the hollow particles are easily mixed and well dispersed. As a result, the hollow particles are evenly distributed in the cell walls of the urethane foam, thereby further reducing the thermal conductivity. However, the thickness of the polyurethane foam composite according to Examples 8 to 10 is about 7 μm, thus about 1 to 2 hollow particles exist in the cell walls. Therefore, the portion of the hollow particles participating in lowering the thermal conductivity is small, and the closed pores inside the polyurethane foam composite are hindered by them, thereby breaking the cell. For the same reason, the thermal conductivities of Examples 8 and 9 are thought to be higher than that of Example 1.

Although exemplary embodiments have been disclosed for illustrative purposes, those skilled in the art will appreciate that various modifications and variations may be made, without departing from the scope and spirit of the invention as defined by the appended claims.

In addition, many modifications can be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguished one element from another. Furthermore, the use of the terms a, an, etc. do not denote a limitation of quantity, but rather denote the presence of at least one of the referenced item.

What is claimed is:

1. A polymer foam composite comprising:
a plurality of hollow cells, each cell being defined by a cell wall; and
wherein a plurality of hollow particles are contained in the cell wall.

2. The polymer foam composite according to claim 1, wherein the polymer is at least one selected from the group consisting olefin resins, polyamide resins, polyurethane resins, and polystyrene resins.

3. The polymer foam composite according to claim 1, wherein the polymer is a polyurethane resin.

4. The polymer foam composite according to claim 1, wherein the cell wall has a thickness of about 4 μm to about 10 μm.

5. The polymer foam composite according to claim 1, wherein the hollow particle comprises an outer wall and a hollow portion defined by the outer wall.

6. The polymer foam composite according to claim 5, wherein the hollow particles have a diameter in the range of about 100 nm to about 4 μm.

7. The polymer foam composite according to claim 5, wherein the outer wall of the hollow particle has a thickness in the range of about 50 nm to about 100 nm.

8. The polymer foam composite according to claim 1, wherein the hollow particles are formed of a homopolymer or a copolymer selected from the group consisting of polyethylene, polypropylene, polystyrene, polyvinyl chloride, polyvinylidene chloride, polyvinyl acetate, polyacrylate-polyester, silane, silicone, polyacrylonitrile, polyacrylate, polymethyl methacrylate, and a mixture thereof.

9. The polymer foam composite according to claim 1, wherein the hollow portion of the hollow particle is filled with air, a fluorocarbon gas, a hydrocarbon gas, an inert gas or a mixture thereof.

10. A process for preparing a polymer foam composite comprising:
adding a catalyst, a dispersant, a foaming agent, and hollow particles to a polyol to prepare a premixed polyol; and
adding isocyanate to the premixed polyol to foam the premixed polyol.

11. The process according to claim 10, wherein the polymer is at least one selected from the group consisting olefin resins, polyamide resins, polyurethane resins, and polystyrene resins.

12. The process according to claim 10, wherein the hollow particles are added in the amount of about 2 to 20 weight % based on the weight of the polyol.

13. The process according to claim 10, wherein the hollow particle has an outer wall and a hollow portion defined by the outer wall, wherein the hollow portion is filled with air, a fluorocarbon gas, a hydrocarbon gas, an inert gas or a mixture thereof.

14. The process according to claim 10, wherein the hollow particle has an outer wall and a hollow portion defined by the outer wall, wherein the hollow particle has a diameter of about 100 nm to about 4 μm and the outer wall of the hollow particle has a thickness of about 50 nm to about 100 nm.

15. The process according to claim 10, wherein the hollow particles are formed of a homopolymer or a copolymer selected from the group consisting of polyethylene, polypropylene, polystyrene, polyvinyl chloride, polyvinylidene chloride, polyvinyl acetate, polyacrylate-polyester, silane, silicone, polyacrylonitrile, polyacrylate, polymethyl methacrylate, and a mixture thereof.

16. The process according to claim 10, wherein the polyol comprises polypropylene glycol polyols, amine terminated polyether polyols, polytetramethylene ether glycol polyol, or adipic acid, the adipic acid being one of polyester polyols, phthalic anhydride and terephthalic acid.

17. The process according to claim 10, wherein the hollow particle is added together with the isocyanate.

18. A polyurethane foam composite formed by foaming a mixture of a polyol, isocyanate, a catalyst, a dispersant, a foaming agent, and hollow particles.

19. The polyurethane foam composite according to claim 18, wherein the hollow particle has an outer wall and a hollow portion defined by the outer wall, wherein the hollow particle has a diameter of about 100 nm to about 4 μm and the outer wall of the hollow particle has a thickness of about 50 nm to about 100 nm.

20. The polyurethane foam composite according to claim 18, wherein the hollow particles are formed of a homopolymer or a copolymer selected from the group consisting of polyethylene, polypropylene, polystyrene, polyvinyl chloride, polyvinylidene chloride, polyvinyl acetate, polyacrylate-polyester, silane, silicone, polyacrylonitrile, polyacrylate, polymethyl methacrylate, and a mixture thereof.

21. The polyurethane foam composite according to claim 18, wherein the hollow portion of the hollow particle is filled with air, a fluorocarbon gas, a hydrocarbon gas, an inert gas or a mixture thereof.
